(19) United States
(12) Patent Application Publication
(10) Pub. No.: US 2008/0100966 A1
(43) Pub. Date: May 1, 2008

(54) Head slider and method of making the same and grinding apparatus for head slider

(75) Inventor: Masahiro Ozeki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,600

(22) Filed: Aug. 24, 2007

(30) Foreign Application Priority Data
Oct. 31, 2006 (JP) 2006-297096

(51) Int. Cl. G11B 5/60

(52) U.S. Cl. 360/235.4

(57) ABSTRACT

A head slider includes a non-magnetic insulating film overlaid on the outflow end surface of a slider body. A second protection film is overlaid on the surface of the non-magnetic insulating film. A heater is embedded in the non-magnetic insulating film to induce a protrusion of the non-magnetic insulating film. A flat ground surface is formed on the second protection film at the tip end of the protrusion. The ground surface has a larger area to contact with a storage medium during a so-called zero calibration. An urging force per unit area is thus reduced. This results in minimization of abrasion of the protrusion. The ground surface instantaneously sticks to the surface of the storage medium. This results in generation of a slight vibration of the head slider. Contact can reliably be detected between the head slider and the storage medium in response to the vibration.

### BACKGROUND OF THE INVENTION

1. Field of the Invention

The present invention relates to a head slider incorporated in a drive such as a hard disk drive, HDD. In particular, the present invention relates to a head slider including a heater embedded in a non-magnetic film in connection with a head element.

2. Description of the Prior Art

A non-magnetic film made of Al₂O₃ (alumina) is overlaid on a slider body made of Al₂O₃—TiC in a head slider, for example. A head element and a heater are embedded in the non-magnetic film. A protection film made of diamond-like-carbon (DLC) is formed on the surface of the non-magnetic film, for example. The protection film covers over the read gap and the write gap of the head element.

Heat of the heater is applied to a thin film coil pattern in the head element. The thermal expansion of the thin film coil pattern enables the read gap and the write gap of the head element to approach a magnetic recording disk. The flying height of the head element can thus be determined depending on the protrusion amount of the thin film coil pattern.

A so-called zero calibration is utilized to determine the protrusion amount. The protrusion amount of the thin film coil pattern is gradually increased in the zero calibration. When the protection film contacts with the magnetic recording disk, the protrusion amount of the thin film coil pattern is captured. The captured protrusion amount is utilized to determine the protrusion amount for writing/reading. The zero calibration thus requires a reliable detection of the contact between the protection film and the magnetic recording disk.

### SUMMARY OF THE INVENTION

It is accordingly an object of the present invention to provide a drive capable of reliably detecting contact between a protection film and a storage medium when a head element protrudes. It is also an object of the present invention to provide a method of making such a drive. Moreover, it is also an object of the present invention to provide a head slider, a method of making the head slider, and a grinding apparatus for the head slider, all significantly contributing to realization of the drive.

According to the present invention, there is provided a drive comprising: a slider body having a medium-opposed surface; a non-magnetic insulating film overlaid on the outflow end surface of the slider body; a rail formed on the medium-opposed surface of the slider body, the rail extending to reach the outflow end of the slider body; a first protection film overlaid on the top surface of the rail; a second protection film formed continuous with the first protection film, the second protection film overlaid on the surface of the non-magnetic insulating film at a position downstream of the rail; a head element embedded in the non-magnetic insulating film at a position downstream of the rail; and a heater embedded in the non-magnetic insulating film, the heater related to the head element. The drive allows formation of a flat ground surface on the second protection film at the tip end of a protrusion of the non-magnetic insulating film when the non-magnetic insulating film forms the protrusion in response to the heat generated by the heater.

The ground surface has a larger area to contact with the storage medium during a so-called zero calibration, for example. An urging force per unit area is thus reduced. This results in minimization of abrasion of the protrusion. Moreover, the ground surface instantaneously sticks to the surface of the storage medium. This results in generation of a slight vibration or sway of the head slider. Contact can reliably be detected between the head slider and the storage medium in response to the vibration. In the case where the tip end of the protrusion on the second protecting film is pointed, the protrusion is prevented from sticking to the surface of the storage medium. This results in prevention of generation of a slight vibration or sway of the head slider. Even if the protrusion contacts with the storage medium, the detection of the contact is thus sometimes missed.

A specific method may be provided to make the aforementioned drive. The method may comprise: causing a head element to protrude toward a storage medium with the assistance of a heater, the head element embedded in a non-magnetic insulating film overlaid on the outflow end surface of the slider body of a head slider, the heater embedded in the non-magnetic insulating film in connection with the head element; detecting contact between the storage medium and a protection film covering over the head element; and increasing the protrusion amount of the head element when the contact has been detected.

The method allows formation of the protection film on the top surface of a rail and the surface of the non-magnetic insulating film prior to formation of a ground surface. The thickness of the protection film is set larger than the minimum thickness required for protection of the head element. The ground surface is formed based on the protection film having such a larger thickness. When the protection film forms a protrusion in response to the heat generated by the heater, the tip end of the protrusion thus establishes a relatively smooth curved surface. This results in a reliable realization of “attachment” or “adhesion” of the protrusion to the storage medium when the protrusion contacts with the storage medium. The contact can thus reliably be detected between the protection film and the storage medium. In the case where the thickness of the protection film is relatively small, the tip end of the protrusion tends to get pointed. The pointed tip end of the protrusion prevents detection of the contact between the protection film and the recording medium. The ground surface is thus excessively ground. The total duration of contact may be set in a range from 0.004 seconds to 3,000 seconds between the storage medium and the protection film, for example. The surface roughness Ra of the storage medium may be set in a range from 0.3 nm to 3.0 nm, for example. The head element may read out magnetic bit data held on the storage medium when increasing the protrusion amount. The output from the head element has a certain correlation with the distance between the head element and the storage medium. The distance between the head element and the storage medium can thus be estimated based on the output from the head element during the grinding. The ground amount can in this manner be grasped with a high accuracy.

The method may further comprise: placing the storage medium in the enclosure of the drive; and placing the head slider in the enclosure of the drive prior to protrusion of the head element. The ground surface can thus be formed after the drive has been assembled. A read signal output from the head element may be utilized to detect the contact. Utilization of the read signal enables the detection of the contact between the protection film and the storage medium without any additional signal wire. Since the ground surface enables the reliable “attachment” or “adhesion” of the protrusion when the protrusion contacts with the storage medium in the same manner as described above, a sign of the contact reliably appears in the read signal.

A specific drive is provided according to the mentioned method. The specific drive may comprise: a slider body having a medium-opposed surface opposed to a storage medium at a distance; a non-magnetic insulating film overlaid on the outflow end surface of the slider body; a rail formed on the medium-opposed surface of the slider body, the rail extending to reach the outflow end of the slider body; a first protection film overlaid on the top surface of the rail, the first protection film having a non-ground surface; a second protection film formed continuous with the first protection film, the second protection film overlaid on the surface of the non-magnetic insulating film at a position downstream of the rail; a head element embedded in the non-magnetic insulating film at a position downstream of the rail; a heater embedded in the non-magnetic insulating film, the heater related to the head element; and a depression at least partly defined on the second protection film, the depression related to the heater. The drive may further comprise a controller circuit specifying the protrusion amount of the non-magnetic insulating film when the flat ground surface contacts with the storage medium, the controller circuit determining the protrusion amount of the protrusion of the non-magnetic insulating film for a normal flight of the slider body at a predetermined flying height, based on the protrusion amount specified when the flat ground surface contacts with the storage medium. The head element is thus allowed to reliably fly above the storage medium at a predetermined flying height.

A specific head slider may be utilized to realize the drive. The specific head slider may comprise: a slider body having a medium-opposed surface; a non-magnetic insulating film overlaid on the outflow end surface of the slider body; a rail formed on the medium-opposed surface of the slider body, the rail extending to reach the outflow end of the slider body; a first protection film overlaid on the top surface of the rail, the first protection film having a non-ground surface; a second protection film formed continuous with the first protection film, the second protection film overlaid on the surface of the non-magnetic insulating film at a position downstream of the rail; a depression at least partly defined on the second protection film; a head element embedded in the non-magnetic insulating film near the outflow end of the rail, the head element having at least a write head located within the depression; and a heater embedded in the non-magnetic insulating film, the heater related to the head element. The head slider may allow formation of a flat ground surface on the second protection film at the tip end of a protrusion of the non-magnetic insulating film when the non-magnetic insulating film forms the protrusion in response to the heat generated by the heater. The depth of the depression may be set in a range from 0.1 nm to 3.0 nm. At least the second protection film may have a margin for grinding in a range from 0.1 nm to 3.0 nm. The second protection film may comprise: a surface layer establishing the margin for grinding; and one or more basic protective layer receiving the surface layer.

A specific method may be employed to realize the head slider. The specific method may comprise: causing a head element to protrude toward a moving grinding surface by utilizing a heater, the head element embedded in a non-magnetic insulating film overlaid on the outflow end surface of the slider body of a head slider, the heater embedded in the non-magnetic insulating film in connection with the head element; detecting contact between the grinding surface and a protection film covering over the head element based on the output from a vibrometer; and increasing the protrusion amount of the head element, when the contact has been detected, so as to grind the protection film with the grinding surface, for example. The total duration of contact between the storage medium and the protection film may be set in a range from 0.004 seconds to 3,000 seconds, for example. The surface roughness Ra of the storage medium may be set in a range from 0.3 nm to 3.0 nm, for example.

A specific grinding apparatus for a head slider may be provided to realize the method, for example. The specific grinding apparatus may comprise: a rotating body having a surface defining a grinding surface, the rotating body rotating around a rotation axis; a supporting mechanism supporting a head suspension, the supporting mechanism designed to oppose a head slider on the head suspension to the grinding surface of the rotating body; a power supplying circuit supplying electric power to a heater; and a vibrometer detecting vibration of the head slider, for example. The vibrometer may be one of a laser Doppler vibrometer, a piezoelectric sensor and an acoustic emission (AE) sensor. The laser Doppler vibrometer, the piezoelectric sensor and the acoustic emission sensor are capable of detecting contact between the head slider and the grinding surface with a high accuracy. Even if the tip end of the protrusion is pointed, the laser Doppler vibrometer, the piezoelectric sensor or the acoustic emission sensor enables detection of the vibration resulting from the contact. On the other hand, in the case where the tip end of the protrusion is pointed, the protrusion is prevented from attachment or adhesion to the grinding surface as described above. This results in failure in detection of the contact. The surface roughness Ra of the grinding surface may be set in a range from 0.3 nm to 3.0 nm.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the structure of a hard disk drive as a specific example of a drive;

FIG. 2 is an enlarged perspective view of a specific example of a flying head slider incorporated in the drive;

FIG. 3 is an enlarged sectional view taken along the line 3-3 in FIG. 2;

FIG. 4 is a front view schematically illustrating the structure of an electromagnetic transducer mounted on the flying head slider;

FIG. 5 is a sectional view taken along the line 5-5 in FIG. 4;

FIG. 6 is a sectional view of a head protection film for schematically illustrating a “protrusion” formed in the flying head slider;

FIG. 7 is a block diagram schematically illustrating a control system of the hard disk drive relating to the electromagnetic transducer and a heating wiring pattern mounted on the flying head slider;

FIG. 8 is a flowchart schematically illustrating the processing of a controller circuit to execute a zero calibration;

FIG. 9 is a flowchart schematically illustrating the processing of the controller circuit to form a ground surface;

FIG. 10 is a schematic view schematically illustrating a grinding device for a head slider; and

FIG. 11 is an enlarged sectional view of a protection film made of a multilayered film, corresponding to FIG. 3.

### DESCRIPTION OF THE PREFERRED EMBODIMENT

FIG. 1 schematically illustrates the inner structure of a hard disk drive, HDD, 11 as an example of a drive or a storage device according to the present invention. The hard disk drive 11 includes an enclosure 12. The enclosure 12 includes a box-shaped base 13 and an enclosure cover, not shown. The base 13 defines an inner space in the form of a flat parallelepiped, for example. The base 13 may be made of a metallic material such as aluminum, for example. Molding process may be employed to form the base 13. The enclosure cover is coupled to the base 13 to close the opening of the base 13. An airtight inner space is defined between the base 13 and the enclosure cover. Pressing process may be employed to form the enclosure cover out of a plate material, for example.

At least one magnetic recording disk 14 as a storage medium is enclosed in the inner space of the base 13. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the inner space of the base 13. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head suspension 21 is attached to the front or tip end of the individual carriage arm 19. The head suspension 21 is designed to extend forward from the tip end of the carriage arm 19. The aftermentioned flexure is attached to the tip end of the head suspension 21. A so-called gimbal spring is defined in the flexure. The gimbal spring allows a flying head slider 22 to change its attitude relative to the head suspension 21. A head element or electromagnetic transducer is mounted on the flying head slider 22 as described later in detail.

When the magnetic recording disk 14 rotates, the flying head slider 22 is allowed to receive airflow generated along the rotating magnetic recording disk 14. The airflow serves to generate a positive pressure or a lift as well as a negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the carriage 16 swings around the vertical support shaft 18 during the flight of the flying head slider 22, the flying head slider 22 is allowed to move along the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

A power source or voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspensions 21 to swing.

As is apparent from FIG. 1, a flexible printed circuit board unit 25 is located on the carriage block 17. The flexible printed circuit board unit 25 includes a head IC (integrated circuit) 27 mounted on a flexible printed wiring board 26. The head IC 27 is connected to the read head element and the write head element of the electromagnetic transducer on the flying head slider 22. A flexible printed wiring board 28 is utilized to connect the head IC 27 to the electromagnetic transducer. The flexible printed wiring board 28 is formed continuous with the individual flexure. The flexible printed wiring board 28 is connected to the flexible printed circuit board unit 25.

The head IC 27 is designed to supply the read head element of the electromagnetic transducer with a sensing current when the magnetic bit data is to be read. The head IC 27 is also designed to supply the write head element of the electromagnetic transducer with a writing current when the magnetic bit data is to be written. The current value of the sensing current is set at a specific value. A small-sized circuit board 29 is located within the inner space of the base 13. A printed circuit board, not shown, is attached to the back surface of the bottom plate of the base 13. The small-sized circuit board 29 and the printed circuit board are designed to supply the head IC 27 with the sensing current and the writing current.

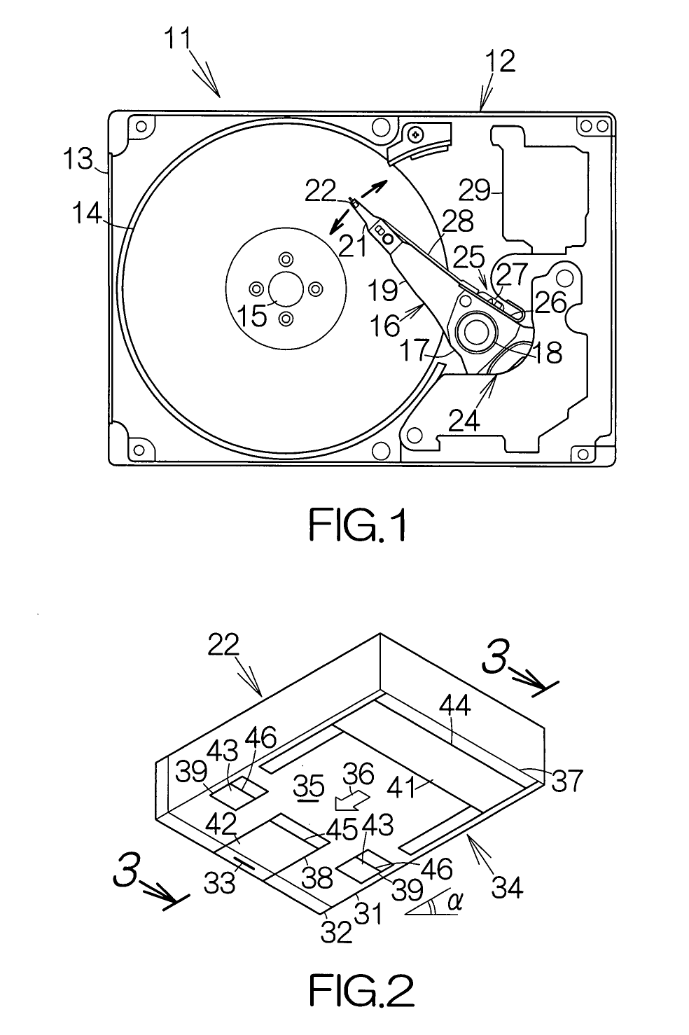

FIG. 2 illustrates a specific example of the flying head slider 22. The flying head slider 22 includes a slider body 31 in the form of a flat parallelepiped, for example. A head protection film 32 is overlaid on the outflow or trailing end of the slider body 31. The aforementioned electromagnetic transducer 33 is embedded in the head protection film 32. The electromagnetic transducer 33 will be described later in detail.

The slider body 31 may be made of a hard non-magnetic material such as Al₂O₃—TiC. The head protection film 32 may be made of a relatively soft non-magnetic insulating material such as Al₂O₃ (alumina). A medium-opposed surface or bottom surface 34 is defined over the slider body 31. The slider body 31 is designed to oppose the bottom surface 34 to the magnetic recording disk 14 at a distance. A flat base surface 35 as a reference surface is defined on the bottom surface 34. When the magnetic recording disk 14 rotates, airflow 36 flows along the bottom surface 34 from the front end toward the outflow or rear end of the slider body 31.

A front rail 37 is formed on the bottom surface 34. The front rail 37 stands upright from the base surface 35 near the inflow end of the base surface 35. The front rail 37 extends along the inflow end of the base surface 35 in the lateral direction of the slider body 31. A rear rail 38 is likewise formed on the bottom surface 34. The rear rail 38 stands upright from the base surface 35 near the outflow end of the base surface 35. The rear rail 38 is located at the middle in the lateral direction of the slider body 31.

A pair of auxiliary rear rails 39, 39 is likewise formed on the bottom surface 34. The auxiliary rear rails 39, 39 stand upright from the base surface 35 near the outflow end of the base surface 35. The auxiliary rear rails 39, 39 are located along the side edges of the base surface 35, respectively. The auxiliary rear rails 39, 39 are thus spaced from each other in the lateral direction. The rear rail 38 is located in a space between the auxiliary rear rails 39, 39.

Air bearing surfaces 41, 42, 43, 43 are defined on the top surfaces of the front rail 37, the rear rail 38 and the auxiliary rear rails 39, 39, respectively. The steps 44, 45, 46, 46 are defined to respectively connect the inflow ends of the air bearing surfaces 41, 42, 43, 43 to the top surfaces of the rails 37, 38, 39, 39. The bottom surface 34 receives the airflow 36 generated along the rotating magnetic recording disk 14. The individual step 44, 45, 46 serves to cause a relatively large positive pressure or lift on the corresponding air bearing surfaces 41, 42, 43. A relatively large negative pressure is generated behind the front rail 37. The negative pressure is balanced with the lift so as to stably establish the flying attitude of the flying head slider 22. It should be noted that the flying head slider 22 may take any shape or form different from the described one.

A first protection film, not shown, is formed on the surface of the slider body 31 at the air bearing surfaces 41, 42, 43, for example. As is apparent from FIG. 3, a second protection film 47 is overlaid on the surface of the head protection film 32 at a position downstream of the rear rail 38. The second protection film 47 may be formed continuous with the first protection film 48, for example. The read gap and the write gap of the aforementioned electromagnetic transducer 33 are exposed on the surface of the head protection film 32 at positions downstream of the air bearing surface 42. The second protection film 47 covers over the read gap and the write gap of the electromagnetic transducer 33 as described later in detail. A depression 49 is formed on the surface of the second protection film 47. At least the write gap of the electromagnetic transducer 33 is located within the depression 49. The first and second protection films 48, 47 maybe made of diamond-like-carbon (DLC), for example. The depression 49 may extend into the first protection film 48. The first and second protection films 48, 47 may have a uniform thickness outside the depression 49.

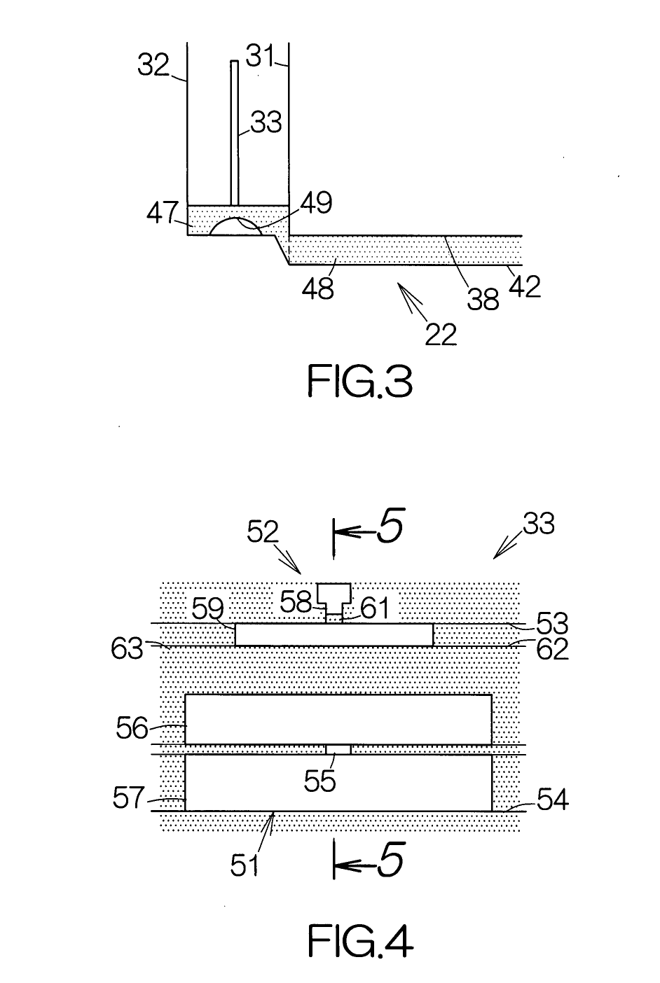

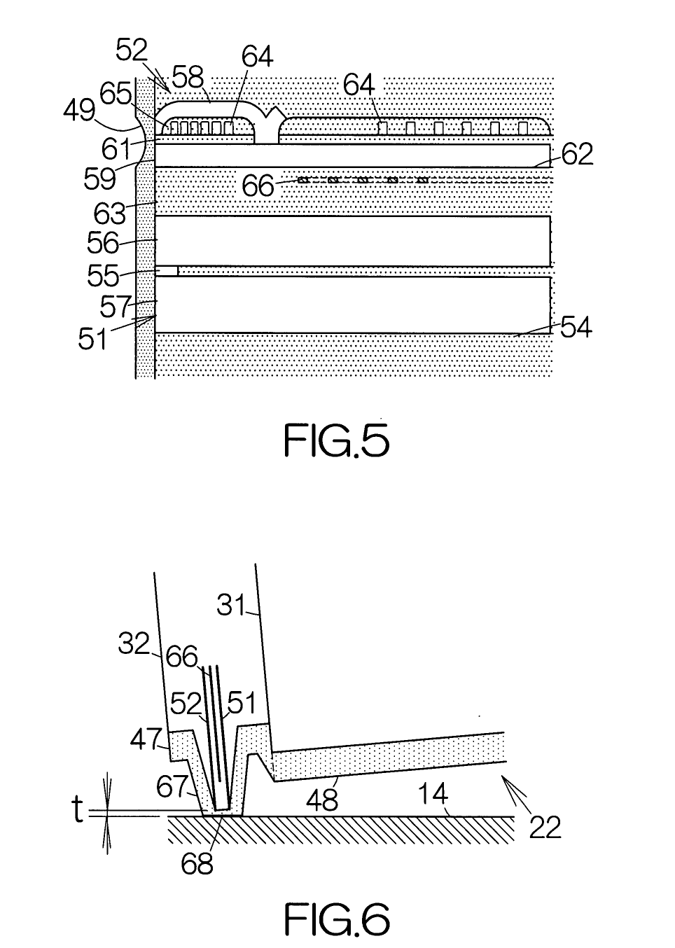

FIG. 4 illustrates the electromagnetic transducer 33 in detail. The electromagnetic transducer 33 includes a CPP (Current-Perpendicular-to-the-Plane) structure read head element 51 and a thin film magnetic head element 52, for example. As conventionally known, the CPP structure read head element 51 is designed to detect variation in the electric resistance in response to the inversion of polarization in the magnetic field applied from the magnetic recording disk 14. The detected variation is utilized to determine magnetic bit data on the magnetic recording disk 14. As conventionally known, the thin film magnetic head element 52 is designed to utilize a magnetic field induced at an electrically-conductive coil pattern, not shown, for example. The induced magnetic field is utilized to write magnetic bit data onto the magnetic recording disk 14. The CPP structure read head element 51 and the thin film magnetic head element 52 are interposed between an Al₂O₃ film 53 and an Al₂O₃ film 54. The Al₂O₃ film 53 corresponds to the upper half of the aforementioned head protection film 32, namely an overcoat film. The Al₂O₃ film 54 corresponds to the lower half of the head protection film 32, namely an undercoat film.

The CPP structure read head element 51 includes a magnetoresistive film 55 such as a spin valve film or a tunnel-junction film. The magnetoresistive film 55 is interposed between an upper electrode 56 and a lower electrode 57. The upper and lower electrodes 53, 54 are designed to expose their front ends at the surface of the head protection film 32. The front ends of the upper and lower electrodes 56, 57 respectively contact with the upper and lower boundaries of the magnetoresistive film 55. The upper and lower electrodes 56, 57 are utilized to supply the sensing current to the magnetoresistive film 55. The upper and lower electrodes 56, 57 may have not only electrical conductivity but also soft magnetism. When each of the upper and lower electrodes 56, 57 is made of a soft magnetic material having electrical conductivity, such as permalloy (NiFe alloy), the upper and lower electrodes 56, 57 can also respectively serve as upper and lower shielding layers of the CPP structure read head element 51. The upper and lower electrodes 56, 57 establish the read gap in this manner.

The thin film magnetic head element 52 includes an upper magnetic pole layer 58 and a lower magnetic pole layer 59. The upper magnetic pole layer 58 defines the front end exposed at the surface of the head protection film 32. The front end of the upper magnetic pole layer 58 is opposed to the magnetic recording disk 14. The lower magnetic pole layer 59 likewise defines the front end exposed at the surface of the head protection film 32. The front end of the lower magnetic pole layer 59 is opposed to the magnetic recording disk 14. The upper and lower magnetic pole layers 58, 59 may be made of FeN, NiFe, or the like. The upper and lower magnetic pole layers 58, 59 in combination establish a magnetic core of the thin film magnetic head element 52.

A non-magnetic gap layer 61 is interposed between the upper and lower magnetic pole layers 58, 59. The non-magnetic gap layer 58 is made of Al₂O₃, for example. When a magnetic field is generated in the aftermentioned thin film coil pattern, magnetic flux is exchanged between the upper and lower magnetic pole layers 58, 59. The non-magnetic gap layer 61 serves to force the magnetic flux to leak from the surface of the head protection film 32 toward the magnetic recording disk 14. The leaked magnetic flux forms a magnetic field for recordation. The upper and lower magnetic pole layers 58, 59 in combination establish a write gap in this manner.

Referring also to FIG. 5, the lower magnetic pole layer 59 extends along a reference plane 62 above the upper electrode 56. The reference plane 62 is defined on the surface of a non-magnetic layer 63 made of Al₂O₃. The non-magnetic layer 63 may be overlaid on the upper electrode 56 by a constant thickness. The non-magnetic layer 63 serves to establish a magnetic isolation between the upper electrode 56 and the lower magnetic pole layer 59.

The non-magnetic gap layer 61 extends on the lower magnetic pole layer 59 by a constant thickness. A thin film coil pattern 64 is located on the non-magnetic gap layer 61. The thin film coil pattern 64 swirls along a plane. The thin film coil pattern 64 is embedded in an insulating layer 65 on the non-magnetic gap layer 61. The aforementioned upper magnetic pole layer 58 is formed on the surface of the insulating layer 65. The upper magnetic pole layer 58 is magnetically connected to the lower magnetic pole layer 59 at the center of the thin film coil pattern 64. Magnetic flux runs through the upper and lower magnetic pole layers 58, 59 in response to the supply of electric current to the thin film coil pattern 64.

A heater is incorporated in the head protection film 32. The heater is related to the electromagnetic transducer 33. The heater includes a heating wiring pattern 66 embedded in the non-magnetic layer 63, for example. The heating wiring pattern 66 may extend along an imaginary plane perpendicular to the surface of the head protection film 32 opposed to the magnetic recording disk 14, for example. Here, since the thin film coil pattern 64 has a relatively large coefficient of thermal expansion, the thin film coil pattern 64 expands in response to the heat of the heating wiring pattern 66 when electric power is supplied to the heating wiring pattern 66. The front end of the thin film coil pattern 64 thus protrudes on the surface of the head protection film 32, as shown in FIG. 6. This results in formation of a protrusion 67. The CPP structure read head element 51 and the thin film magnetic head element 52 thus get closer to the magnetic recording disk 14. This results in establishment of a so-called thermal actuator. The protrusion amount of the thin film magnetic head element 52 serves to determine the flying height of the thin film magnetic head element 52, for example. When the protrusion 67 protrudes toward the surface of the magnetic recording disk 14 by the maximum protrusion amount for a normal flight of the flying head slider 22 at a predetermined flying height, a flat ground surface 68 is formed on the second protection film 47 at the tip end of the protrusion 67. The thickness of the second protection film 47 on the tip end of the protrusion 67 is set at the minimum thickness t required for protection of the CPP structure read head element 51 and the thin film magnetic head element 52.

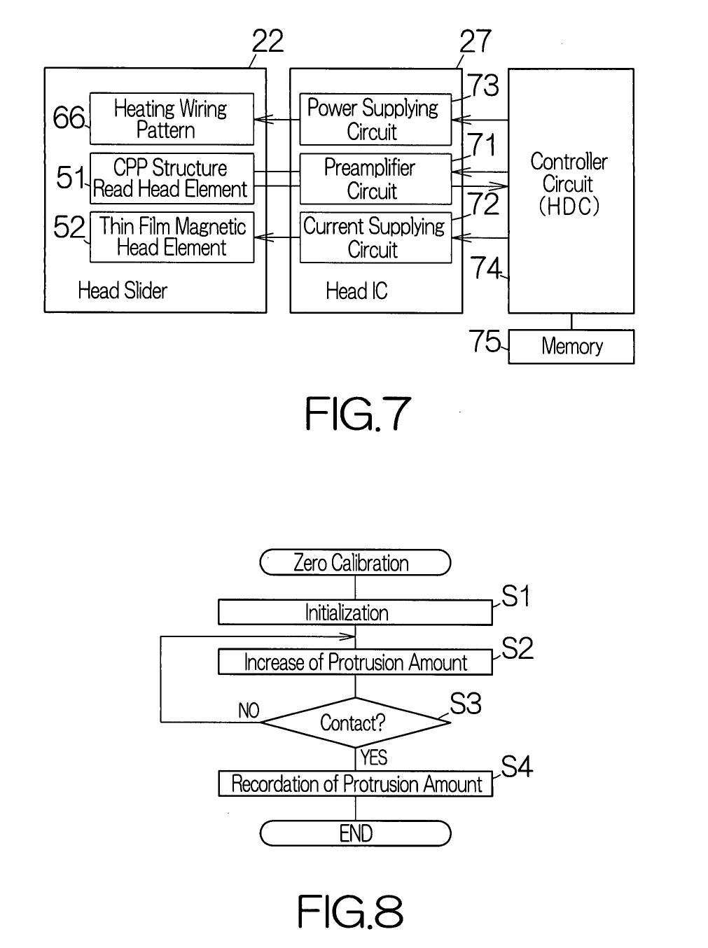

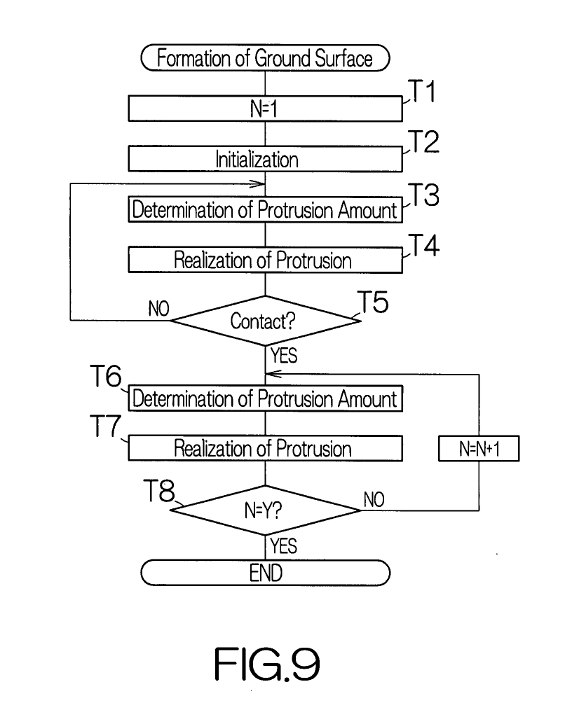

As shown in FIG. 7, a preamplifier circuit 71, a current supplying circuit 72 and a power supplying circuit 73 are incorporated in the head IC 27. The preamplifier circuit 71 is connected to the CPP structure read head element 51. The sensing current is supplied to the CPP structure read head element 51 from the preamplifier circuit 71. The current value of the sensing current is kept constant.

The current supplying circuit 72 is connected to the thin film magnetic head element 52. The writing current is supplied to the thin film magnetic head element 52 from the current supplying circuit 72. A magnetic field is induced in the thin film magnetic head element 52 based on the supplied writing current.

The power supplying circuit 73 is connected to the heating wiring pattern 66. The power supplying circuit 73 is designed to supply predetermined electric power to the heating wiring pattern 66. The heating wiring pattern 66 gets heated in response to the supply of the electric power. The temperature of the heating wiring pattern 66 is determined depending on electric energy. Specifically, the protrusion amount of the protrusion 67 is controlled based on the electric energy.

A hard disk controller (HDC) or controller circuit 74 is connected to the head IC 27. The controller circuit 74 is designed to control the head IC 27 for the supply of the sensing current, the writing current and the electric power. The controller circuit 74 is also designed to detect the voltage of the sensing current. The preamplifier circuit 71 amplifies the voltage of the sensing current prior to the detection.

The controller circuit 74 determines binary data based on the output from the preamplifier circuit 71. The controller circuit 74 also detects “jiggle” or “vibration” of the voltage based on the output from the preamplifier circuit 71. When the aforementioned protrusion 67 contacts the magnetic recording disk 14, for example, the flying head slider 22 is subjected to a slight vibration. This results in generation of the “jiggle” in the voltage of the sensing current. The controller circuit 74 is designed to detect the “jiggle”.

The controller circuit 74 is designed to control the operations of the preamplifier circuit 71, the current supplying circuit 72 and the power supplying circuit 73 in accordance with a predetermined software program. The software program may be stored in a memory 75, for example. The software program is utilized for the aftermentioned zero calibration and the formation of the ground surface 68. Required data may also be stored in the memory 75. The software program and the data may be supplied to the memory 75 from other storage medium/media. The controller circuit 74 and the memory 75 may be mounted on the small-sized circuit board 29, for example.

The protrusion amount of the thin film magnetic head element 52 is determined prior to reading/writing operations of magnetic bit data in the hard disk drive 11. The zero calibration is executed to determine the protrusion amount. The protrusion amount of the protrusion 67 is measured in the zero calibration at the moment when the protrusion 67 contacts with the magnetic recording disk 14. The protrusion amount of the protrusion 67 for reading/writing operation, in other words, for the normal flight of the flying head slider 22, is determined based on the measured protrusion amount. When the protrusion amount of the protrusion 67 for reading/writing operations is determined, the electromagnetic transducer, namely the thin film magnetic head element 52, is allowed to fly above the surface of the magnetic recording disk 14 at a predetermined flying height H. The zero calibration may be executed at every startup or boot of the hard disk drive 11, for example.

The controller circuit 74 executes the predetermined software program for the zero calibration. As shown in FIG. 8, the controller circuit 74 first initializes the hard disk drive 11 at step S1. The controller circuit 74 instructs the spindle motor 15 to drive in the initialization. The magnetic recording disk 14 is driven to rotate at a predetermined speed. The controller circuit 74 also instructs the voice coil motor 24 to drive the carriage 16. The carriage 16 is driven to swing around the vertical support shaft 18. The flying head slider 22 is thus opposed to the surface of the magnetic recording disk 14. The flying head slider 22 flies above the magnetic recording disk 14 at a predetermined flying height. In addition, the controller circuit 74 supplies electric current to the head IC 27. The controller circuit 74 monitors the output from the preamplifier circuit 71. Specifically, the controller circuit 74 observes the voltage level of the sensing current. The power supplying circuit 73 suspends the supply of electric power at this moment.

When the initialization has been completed, the controller circuit 74 supplies an instruction signal to the power supplying circuit 73 to increase the protrusion amount of the protrusion 67 by a predetermined increment at step S2. The power supplying circuit 73 supplies the heating wiring pattern 66 with electric power in response to the reception of the instruction signal. The electric energy of the supplied electric power corresponds to the amount realizing the protrusion amount including the increment of protrusion. The increment may be set at 0.1 nm, for example. The power energy may beforehand be determined depending on the coefficient of thermal expansion of the thin film magnetic head element 52, for example.

When the protrusion amount of the protrusion 67 has been increased, the controller circuit 74 judges the “contact” at step S3. The controller circuit 74 observes whether or not the aforementioned “jiggle” appears in the voltage of the sensing current. In the case where “jiggle” cannot be observed, the processing of the controller circuit 74 returns to step S2. The controller circuit 74 again supplies an instruction signal to the power supplying circuit 73 to increase the protrusion amount of the protrusion 67 by the predetermined increment.

The controller circuit 74 outputs instruction signals to increase the protrusion amount of the protrusion 67 until the “jiggle” is observed at step S3. When the “jiggle” is observed at step S3, the controller circuit 74 determines the contact having occurred between the protrusion 67 and the magnetic recording disk 14. The processing of the controller circuit 74 then proceeds to step S4. The controller circuit 74 specifies the protrusion amount of the protrusion 67. The protrusion amount of the protrusion 67 at the moment when the protrusion 67 has contacted the magnetic recording disk 14 is in this manner determined. The determined protrusion amount is stored in the memory 75, for example. The zero calibration has been completed.

Here, the flat ground surface 68 is formed at the tip end of the protrusion 67 in the aforementioned flying head slider 22. The ground surface 68 has a larger area to contact with the magnetic recording disk 14. An urging force per unit area is thus reduced. This results in minimization of abrasion of the protrusion 67. Moreover, the ground surface 68 instantaneously sticks to the surface of the magnetic recording disk 14. This results in generation of a slight vibration or sway of the flying head slider 22. The “jiggle” can thus reliably be generated in the voltage of the sensing current. In the case where the tip end of the protrusion 67 is pointed, the protrusion 67 is prevented from sticking to the surface of the magnetic recording disk 14. This results in prevention of generation of a slight vibration or sway of the flying head slider 22. Even if the protrusion 67 contacts the magnetic recording disk 14, “jiggle” thus fails to appear in the voltage value of the sensing current. It is not possible to accurately measure the protrusion amount of the protrusion 67 at the moment when the protrusion 67 has contacted the magnetic recording disk 14.

Next, description will be made on a method of forming the ground surface 68 in the process of making the hard disk drive 11. Here, the first protection film 48 having a predetermined thickness is formed at least on the air bearing surface 42 of the rear rail 38 in a method of making the flying head slider 22. The second protection film 47 having the thickness equal to the thickness of the first protection film 48 is formed on the surface of the head protection film 32 at a position downstream of the air bearing surface 42. The first and second protection films 48, 47 may be formed together in the same process. The thickness of the first and second protection films 48, 47 is set equal to the total sum of the aforementioned minimum thickness t and a margin for grinding, namely an additional thickness layer. The first and second protection films 48, 47 are set to have a uniform thickness. The margin for grinding may appropriately be set in a range from 0.1 nm to 3.0 nm, for example.

The ground surface 68 is formed after the hard disk drive 11 has been assembled. In other words, the flying head slider 22 is incorporated in the enclosure 12 of the hard disk drive 11. The controller circuit 74 executes the predetermined software program to form the ground surface 68. As shown in FIG. 9, the controller circuit 74 first sets “1” for a variable N at step T1. The controller circuit 74 executes initialization at step T2. The processing of this initialization is identical to the processing of the aforementioned initialization at step S1 in FIG. 8. When the initialization has been completed, the controller circuit 74 determines the protrusion amount of the protrusion 67 at step T3. A predetermined increment is added to the existing protrusion amount. The increment may be set at 0.1 nm, for example.

The controller circuit 74 instructs to form the protrusion 67 based on the determined protrusion amount at step T4. An instruction signal is supplied to the power supplying circuit 73. The power supplying circuit 73 supplies electric power to the heating wiring pattern 66 in response to the supply of the instruction signal. The electric energy of the electric power corresponds to an amount realizing the determined protrusion amount. The power supplying circuit 73 instantaneously outputs electric power. The protrusion 67 is thus instantly withdrawn or canceled.

The controller circuit 74 judges the “contact” between the protrusion 67 and the magnetic recording disk 14 at step T5. The controller circuit 74 observes whether or not the “jiggle” appears in the voltage value of the sensing current in the same manner as described above. When “jiggle” cannot be observed, the processing of the controller circuit 74 returns to step T3. The controller circuit 74 again determines the protrusion amount of the protrusion 67. The predetermined increment is added to the existing protrusion amount. The tip end of the protrusion 67 thus gets closer to the magnetic recording disk 14 by the increment until the “contact” is observed.

When the “jiggle” is observed at step T5, the controller circuit 74 determines that the contact occurs between the protrusion 67 and the magnetic recording disk 14. The processing of the controller circuit 74 proceeds to step T6. The controller circuit 74 determines the protrusion amount of the protrusion 67 at step T6. The predetermined increment is added to the existing protrusion amount of the protrusion 67, namely the protrusion amount at the moment when the protrusion 67 has contacted the magnetic recording disk 14. The increment may be set at 0.1 nm, for example.

The controller circuit 74 instructs formation of the protrusion 67 based on the determined protrusion amount at step T7. An instruction signal is supplied to the power supplying circuit 73. The power supplying circuit 73 supplies electric power to the heating wiring pattern 66 in response to the supply of the instruction signal. The electric energy of the electric power corresponds to the determined protrusion amount. The power supplying circuit 73 maintains the output of the electric power for a predetermined duration. Since the tip end of the protrusion 67 keeps contacting the magnetic recording disk 14, the urging force from the head suspension 21 urges the protrusion 67 against the surface of the magnetic recording disk 14. The tip end of the protrusion 67 is thus ground. The aforementioned predetermined duration is set at the minimum duration required to achieve a ground amount corresponding to the protrusion amount. The surface roughness Ra of the magnetic recording disk 14 may be set in a range from 0.3 nm to 3.0 nm, for example. Only the tip end of the protrusion 67 in the flying head slider 22 contacts the magnetic recording disk 14. The first protection film 48 is thus kept non-ground on the air bearing surfaces 41, 42, 43, 43. In the case where the bottom surface 34 of the flying head slider 22 is urged against a grinding surface such as a faceplate, for example, grinding marks or scratches are formed on the surfaces of the first and second protection films 48, 47.

The controller circuit 74 determines the ground amount at step T8. The controller circuit 74 counts up the number of times N for incrementing the protrusion amount. The maximum number of times Y is set based on the thickness of the margin for grinding. When the thickness of the margin for grinding is set at 3.0 nm, for example, the maximum number Y is set at 30 for the increment of 0.1 nm. The ground amount is determined depending on the thickness of the margin for grinding.

In the case where the number of times N is less than the maximum number of times Y, the processing of the controller circuit 74 returns to step T6. The controller circuit 72 again determines the protrusion amount of the protrusion 67 at step T6. The predetermined increment is added to the existing protrusion amount of the protrusion 67, namely the protrusion amount at the moment when the protrusion 67 has the magnetic recording disk 14. The grinding process is executed several times to achieve the ground amount for the increment of the protrusion amount. When the number of times N reaches the maximum number of times Y at step T8, the controller circuit 74 terminates the processing. The total duration of the grinding process is set in a range from 0.004 seconds to 3,000 seconds. The controller circuit 74 instructs the spindle motor 15 to stop driving. The controller circuit 74 also instructs the voice coil motor 24 to retreat the carriage 16. The controller circuit 74 stops supplying the preamplifier circuit 71 with the electric current. The controller circuit 74 instructs the power supplying circuit 73 to stop supplying the electric power. Formation of the ground surface 68 is thus completed. When the thermal expansion of the heating wiring pattern 66 disappears, the depression 49 is formed on the second protection film 47. The depth of the depression 49 corresponds to the ground amount.

The aforementioned method allows establishment of the first and second protection films 48, 47 on the air bearing surfaces 41, 42, 43, 43 and the surface of the head protection film 32 prior to the formation of the ground surface 68. The thickness of the first and second protection films 48, 47 is set larger than the minimum thickness t as described above. The protrusion 67 is formed based on the second protection film 47 having the larger thickness. The tip end of the protrusion 67 thus establishes a relatively smooth curved surface. This results in a reliable realization of “attachment” or “adhesion” of the protrusion 67 when the protrusion 67 contacts the magnetic recording disk 14. The contact can reliably be detected between the protrusion 67 and the magnetic recording disk 14. In the case where the thickness of the second protection film 47 is relatively small, the tip end of the protrusion 67 tends to get pointed. The pointed tip end of the protrusion 67 prevents the detection of the contact between the protrusion 67 and the magnetic recording disk 14 as described above. The ground surface 68 is thus excessively ground.

The controller circuit 74 may keep observing the sensing current during the grinding of the protrusion 67. The output from the CPP structure read head element 51 has a certain correlation with the distance between the CPP structure read head element 51 and the magnetic recording disk 14. The voltage level of the sensing current can thus be utilized to estimate the distance between the CPP structure read head element 51 and the magnetic recording disk 14 during the grinding. The ground amount of the protrusion 67 is in this manner captured with a high accuracy. The CPP structure read head element 51 may be supplied with the sensing current in the same manner as described above. Any data may beforehand be written into the magnetic recording disk 14.

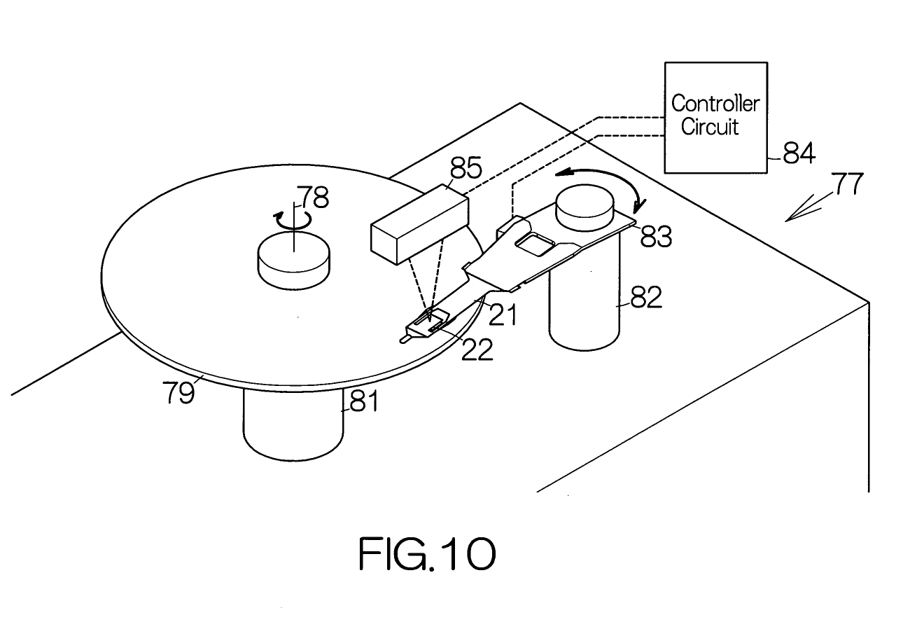

A grinding device 77 may be utilized to form the ground surface 68. As shown in FIG. 10, the grinding device 77 includes a rotating body, namely a faceplate 79, for example. The faceplate 79 is designed to rotate around a rotation axis 78. A magnetic recording disk may be employed as the faceplate 79, for example. A grinding surface is established on the surface of the faceplate 79. The surface roughness Ra of the grinding surface may be set in a range from 0.3 nm to 3.0 nm, for example. A spindle motor 81 may be employed to drive the faceplate 79 for rotation.

A supporting mechanism 82 is related to the faceplate 79. The supporting mechanism 82 includes an actuator arm 83. The head suspension 21 is supported on the tip end of the actuator arm 83. The flying head slider 22 and the flexure have previously been attached to the head suspension 21. The supporting mechanism 82 may have the structure identical to the structure of the aforementioned carriage 16. The supporting mechanism 82 allows the flying head slider 22 to face the grinding surface of the faceplate 79. The flying head slider 22 is kept flying above the grinding surface of the faceplate 79 at a predetermined flying height during the rotation of the faceplate 79 around the rotation axis 78 in the same manner as described above.

A controller circuit 84 is connected to the head suspension 21. The aforementioned flexible printed wiring board 28 may be utilized to connect the controller circuit 84. Here, the preamplifier circuit 71 and the power supplying circuit 73 are incorporated in the controller circuit 84. The preamplifier circuit 71 supplies the sensing current to the CPP structure read head element 51 on the flying head slider 22. The power supplying circuit 73 supplies electric power to the heating wiring pattern 66. The current supplying circuit 72 may be incorporated in the controller circuit 84 to supply electric current to the thin film magnetic head element 52. The preamplifier circuit 71, the power supplying circuit 73 and the current supplying circuit 72 may have the structure identical to the structure of the aforementioned head IC 27.

A laser Doppler vibrometer 85 is located behind the flying head slider 22. The laser Doppler vibrometer 85 may be supported on the actuator arm 83, for example. The laser Doppler vibrometer 85 is designed to detect vibration in the flying head slider 22. The output from the laser Doppler vibrometer 85 is supplied to the controller circuit 84.

The controller circuit 84 executes the processing identical to the processing of the aforementioned controller circuit 74 to form the ground surface 68. It should be noted that the contact is detected between the protrusion 67 and the faceplate 79 in response to the output from the laser Doppler vibrometer 85. The laser Doppler vibrometer 85 is capable of detecting the contact between the flying head slider 22 and the faceplate 79 with a higher accuracy as compared with detection of “jiggle” in a read signal. Even if the tip end of the protrusion 67 is pointed, the laser Doppler vibrometer 85 is sufficiently capable of detecting vibration caused by the contact. On the other hand, in the case where the tip end of the protrusion 67 is pointed, the protrusion 67 is prevented from attaching to the grinding surface as described above. This results in failure in detection of the contact. A piezoelectric sensor or an acoustic emission (AE) sensor may be utilized in the grinding device 77 in place of the laser Doppler vibrometer 85. The piezoelectric sensor and the acoustic emission sensor are capable of detecting contact between the protrusion 67 and the grinding surface of the faceplate 79 as accurately as the laser Doppler vibrometer 85. The piezoelectric sensor or the acoustic emission sensor may be fixed on the actuator arm 83 at a position adjacent to the head suspension 21, for example.

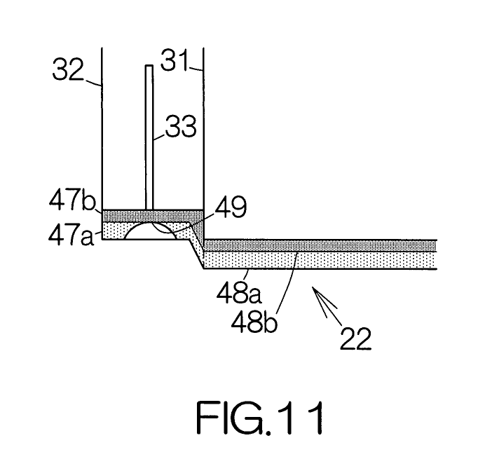

It should be noted that the first and second protection films 48, 47 may be so-called multilayered films as shown in FIG. 11, for example. Here, the first and second protection films 48, 47 include surface layers 48a, 47a, respectively. Each of the surface layers 48a, 47a establishes the aforementioned margin for grinding. The surface layers 48a, 47a are received on the surfaces of basic protective layers 48b, 47b, respectively. The basic protective layers 48b, 47b are received on the slider body 31 and the surface of the head protection film 32. The first and second protection films 48, 47 can be made of the multilayered films made of different materials from each other. Each of the basic protective layers 48b, 47b may be made of diamond-like-carbon (DLC), for example. Each of the surface layers 48a, 47a may be made of a material capable of more easily sticking to the magnetic recording disk 14 as compared with DLC, for example. The surface layers 48a, 47a may be formed continuous over the slider body 31 and the head protection film 32. The basic protective layers 48b, 47b may also be formed continuous over the slider body 31 and the head protection film 32.

What is claimed is:

1. A drive comprising:
a slider body having a medium-opposed surface;
a non-magnetic insulating film overlaid on an outflow end surface of the slider body;
a rail formed on the medium-opposed surface of the slider body, the rail extending to reach an outflow end of the slider body;
a first protection film overlaid on a top surface of the rail, the first protection film having a non-ground surface;
a second protection film formed continuous with the first protection film, the second protection film overlaid on a surface of the non-magnetic insulating film at a position downstream of the rail;
a head element embedded in the non-magnetic insulating film at a position downstream of the rail;
a heater embedded in the non-magnetic insulating film, the heater related to the head element; and
a depression at least partly defined on the second protection film, the depression related to the heater.

2. The drive according to claim 1, wherein a flat ground surface is formed on the second protection film at a tip end of a protrusion of the non-magnetic insulating film when the non-magnetic insulating film forms the protrusion in response to heat generated by the heater.

3. The drive according to claim 2, further comprising a controller circuit specifying a protrusion amount of the protrusion of the non-magnetic film when the flat ground surface contacts with the storage medium, the controller circuit determining a protrusion amount of the protrusion of the non-magnetic insulating film for a normal flight of the slider body at a predetermined flying height, based on the protrusion amount specified when the flat ground surface contacts with the storage medium.

4. The drive according to claim 3, wherein a depth of the depression is set in a range from 0.1 nm to 3.0 nm.

5. The drive according to claim 4, wherein at least the second protection film has a margin for grinding in a range from 0.1 nm to 3.0 nm.

6. The drive according to claim 5, wherein the second protection film comprises:
a surface layer establishing the margin; and
one or more basic protective layer receiving the surface layer.

7. A method of making a drive, comprising:
causing a head element to protrude toward a storage medium with the assistance of a heater, the head element embedded in a non-magnetic insulating film overlaid on an outflow end surface of a slider body of a head slider, the heater embedded in the non-magnetic insulating film in connection with the head element;
detecting contact between the storage medium and a protection film covering over the head element; and
increasing a protrusion amount of the head element when the contact has been detected.

8. The method according to claim 7, further comprising:
placing the storage medium in an enclosure of the drive; and
placing the head slider in the enclosure of the drive prior to protrusion of the head element, wherein
a read signal output from the head element is utilized to detect the contact.

9. The method according to claim 8, wherein a total duration of contact is set in a range from 0.004 seconds to 3,000 seconds between the storage medium and the protection film.

10. A head slider comprising:
a slider body having a medium-opposed surface;
a non-magnetic insulating film overlaid on an outflow end surface of the slider body;
a rail formed on the medium-opposed surface of the slider body, the rail extending to reach an outflow end of the slider body;
a first protection film overlaid on a top surface of the rail, the first protection film having a non-ground surface;
a second protection film formed continuous with the first protection film, the second protection film overlaid on a surface of the non-magnetic insulating film at a position downstream of the rail;
a head element embedded in the non-magnetic insulating film at a position downstream of the rail; and
a heater embedded in the non-magnetic insulating film, the heater related to the head element; and
a depression at least partly defined on the second protection film, the depression related to the heater.

11. The head slider according to claim 10, wherein a flat ground surface is formed on the second protection film at a tip end of a protrusion of the non-magnetic insulating film when the non-magnetic insulating film forms the protrusion in response to heat generated by the heater.

12. The head slider according to claim 11, wherein a depth of the depression is set in a range from 0.1 nm to 3.0 nm.

13. The head slider according to claim 12, wherein at least the second protection film has a margin for grinding in a range from 0.1 nm to 3.0 nm.

14. The head slider according to claim 13, wherein the second protection film comprises:
a surface layer establishing the margin; and
one or more basic protective layer receiving the surface layer.

15. A grinding apparatus for a head slider, comprising:
a rotating body having a surface defining a grinding surface, the rotating body rotating around a rotation axis;
a supporting mechanism supporting a head suspension, the supporting mechanism designed to oppose a head slider on the head suspension to the grinding surface of the rotating body;
a power supplying circuit supplying electric power to a heater; and
a vibrometer detecting vibration of the head slider.

16. The grinding apparatus according to claim 15, wherein the vibrometer is one of a laser Doppler vibrometer, a piezoelectric sensor and an acoustic emission sensor.

17. The grinding apparatus according to claim 16, wherein the rotating body is a magnetic storage medium having a magnetic layer on a substrate.

18. The grinding apparatus according to claim 17, further comprising a controller circuit instructing a head element on the head slider to read out magnetic bit data held on the magnetic storage medium.

19. A method of making a head slider, comprising:
causing a head element to protrude toward a moving grinding surface by utilizing a heater, the head element embedded in a non-magnetic insulating film overlaid on an outflow end surface of a slider body of a head slider, the heater embedded in the non-magnetic insulating film in connection with the head element;
detecting contact between the grinding surface and a protection film covering over the head element based on output from a vibrometer; and
increasing a protrusion amount of the head element, when the contact has been detected, so as to grind the protection film with the grinding surface.
